(19) United States
(12) Patent Application Publication
(10) Pub. No.: US 2013/0002402 A1
(43) Pub. Date: Jan. 3, 2013

(54) SIGNALING DEVICE

(76) Inventors: Levi Lior Guttman, Tel Aviv (IL); Mendel Rubinstein, Tel Aviv (IL)

(21) Appl. No.: 13/634,557

(22) PCT Filed: Mar. 16, 2011
(86) PCT No.: PCT/IL2011/000250

§ 371 Date: Sep. 13, 2012

Related U.S. Application Data
(60) Provisional application No. 61/314,200, filed on Mar. 16, 2010.

(51) Int. Cl. G08B 5/22

(52) U.S. Cl. 340/8.1

(57) ABSTRACT

A system and method for locating an object, the system including a signaling device for mounting on an object, the signaling device including a signaling transceiver transmitting an identification signal, and a signal locator including a locator transceiver for receiving a signal directly from the signaling device, a direction sensor for sensing a direction towards which the signal locator is pointing, a locator controller determining, from the received signal and from the sensed direction, a direction from which the identification signal is received by the signal locator, and an indicator indicating that direction. Preferably, the signaling device further includes a signaling controller coupled to the signaling transceiver, which automatically switches the transmitter between a contact mode, to establish contact with the signal locator, and an operational mode, to permit determination by the signal locator of that direction, after contact has been established.

### FIELD OF THE INVENTION

The present invention relates to a signaling device, in general and, in particular, to a signaling device for locating lost objects.

### BACKGROUND OF THE INVENTION

Often people misplace objects in the house or the office, especially objects which are relatively small, such as passports, keys, wallet, etc. Typically, one may spend a lot of time searching for these objects, attempting to recall where they were placed, or where they were last seen.

In order to solve this problem, a number of devices for locating objects have been suggested. These devices usually include an electronic tag which is mounted on an object, preferably, one which the user often misplaces, and a detecting device which is configured to detect the presence of the electronic tag, and indicate to the user that the object, on which the electronic tag is mounted, is in close proximity.

Some of these electronic tags are RFID (radio frequency identification) tags, and include an integrated circuit for storing and processing information, modulating and demodulating a radio-frequency (RF) signal. The RFID tag may be a passive RFID tag, which has no power source and requires an external electromagnetic field to initiate a signal transmission. Alternatively, the RFID tag may be an active RFID tag, which is coupled to a power source and can transmit signals once a prompting signal from a detecting device is identified.

Some other electronic tags include a Bluetooth transceiver, and are configured to communicate with a compatible Bluetooth searching device. The searching device is configured to transmit a Bluetooth signal, which is received by the tag, which, in response, transmits an identification signal.

Typically, these object locators detect the presence of the tag which is mounted on an object, and indicate to the user that the object is in close proximity. The indication may include a visual indication, such as a message displayed on a screen, or alternatively, may include an audible indication, such as a beep.

However, these devices do not include an indication directing the user to the exact location or the direction in which the object is located. In addition, some of these electronic tags consume a lot of power, and thus, cannot be used for a long period of time without replacing or recharging the power source.

Accordingly, there is a long felt need for a device for locating objects which can provide an indication of the direction in which the user should be searching, and it would be very desirable to have an electronic tag for mounting on objects, which consumes relatively low power, and thus can be used for a long period of time.

### SUMMARY OF THE INVENTION

There is provided, in accordance with the present invention, a system for locating an object, the system including a signaling device for mounting on an object, the signaling device including a signaling transceiver transmitting an identification signal, and a signal locator including a locator transceiver for receiving a signal directly from the signaling device, a direction sensor for sensing a direction towards which the signal locator is pointing, a locator controller determining, from the received signal and from the sensed direction, a direction from which the identification signal is received by the signal locator, and an indicator indicating that direction.

According to some embodiments of the invention, the signaling transceiver is a variable transmit power transceiver and the signaling device further includes a signaling controller coupled to the signaling transceiver, where the signaling controller automatically switches the transmitter between a contact mode, to establish contact with the signal locator, and an operational mode, to permit determination by the signal locator of that direction, after contact has been established.

Preferably, the system also includes a display for providing a visible indication of the determined direction.

There is also provided, according to the invention, a signaling device for sending signals to a signal locator. The device includes a transceiver configured for selectively transmitting a signal in a first transmitting mode, to establish contact with the signal locator, and for transmitting the signal in a second transmitting mode after contact has been established, to permit determination by the signal locator of the direction from which the signal was received, and a controller for automatically switching between the first and second transmitting modes.

The signaling transceiver can be coupled to an omnidirectional antenna, and the first transmitting mode includes transmitting through the omnidirectional antenna at high power, and the second transmitting mode includes transmitting through the omnidirectional antenna at low power.

Alternatively, the signaling transceiver can be coupled to an omnidirectional antenna and at least two unidirectional antennas, and the first transmitting mode includes transmitting through the omidirectional antenna and the unidirectional antennas, and the second transmitting mode includes transmitting through at least one of the unidirectional antennas.

According to a preferred embodiment, the device is a cellular phone, a hand held computing device. According to another preferred embodiment, the signal locator is mounted on an electronic card configured to be plugged into a memory slot in a conventional hand held computing device or cellular phone.

There is further provided according to the invention, a method for locating an object having a signaling device. The method includes receiving, in a signal locator, an identification signal directly from a signaling device, sensing, in the signal locator, a direction towards which the signal locator is pointing, determining, from the identification signal and the sensed direction, a direction from which the identification signal is received by the signal locator, and providing an indication of the determined direction.

There is also provided, according to the invention, a method for locating an object having a signaling device, this method including receiving a prompt signal from a signal locator in a signaling device, transmitting an identification signal in a contact mode by the signaling device in response to the prompting signal, automatically switching to an operation mode, different from the contact mode, in the signaling device, and transmitting the identification signal in the operation mode.

### BRIEF DESCRIPTION OF THE DRAWINGS

The present invention will be further understood and appreciated from the following detailed description taken in conjunction with the drawings in which:

FIG. 1a is a block diagram illustration of a signaling device constructed and operative in accordance with one embodiment of the present invention;

FIG. 1b is a block diagram illustration of a signal locator constructed and operative in accordance with one embodiment of the present invention;

FIG. 2 is a schematic illustration of a system including the signaling device of FIG. 1a, mounted on an object, and the signal locator of FIG. 1b;

FIG. 3 is a block diagram illustration of a signaling device constructed and operative in accordance with another embodiment of the present invention; and

FIG. 4 is a schematic illustration of a system including the signaling device of FIG. 3, mounted on an object, and a signal locator.

### DETAILED DESCRIPTION OF THE INVENTION

The present invention relates to a system for locating an object, the system including a signaling device for mounting on the object and a signal locator for locating the signaling device, thereby locating the object. It is a particular feature of the present invention that the signal locator identifies the direction from which the signaling device is transmitting the signal. Thus, the signal locator can indicate to a user the direction of the location of the signaling device relative to the signal locator. In this way, a user can easily locate the object on which the signaling device is mounted. It is a particular feature of the invention that the signal locator can be incorporated in a conventional cellular phone, hand held PDA, or similar device.

The signaling device includes a transceiver, preferably a variable power transceiver capable of transmitting at different, selectable, power levels, and at least one antenna for transmitting a signal. The transmitter is coupled to a power source and to a controller, for controlling the operation of the transmitter and the power source. The signaling device further includes a mounting element for coupling the signaling device to an object.

The signal locator includes a transceiver for receiving a signal from the signaling device, a direction sensor sensing the direction towards which the signal locator is pointing, a controller for processing the received signal together with the sensed direction and for determining the signal direction, and an indicator for indicating the determined direction from which the signal is transmitted.

According to an embodiment of the invention, the signaling device transmits a signal after receiving a prompting signal from the signal locator. The signal locator detects the direction from which the signal is received, and displays an indication pointing to that direction. In order to receive an accurate indication of the direction, the user holds the signal locator close to his or her body, pointing forwards. If part of the user's body is between the signal locator and the signaling device, the user's body will reduce the amplitude of the electromagnetic waves received by the signal locator. As the user turns his or her body left or right, while holding the signal locator adjacent his or her body, the signal locator indicates the direction from which the signal is received, thus indicating to the user where he or she should look for the object on which the signaling device is located, as described in detail below.

According to another embodiment of the invention, the transmitter of the signaling device is configured to selectively transmit a signal in a first transmitting mode, a contact mode, to establish a connection with a signal locator (as described hereinbelow), and in a second transmitting mode, an operational mode, to permit determination of the direction (as described herein below) and also to conserve energy. When the transmitter operates in the first transmitting mode, such as utilizing a plurality of antennas or transmitting at full power, the signal locator can make an initial detection and identification of the signal. However, it might be difficult to accurately identify the direction from which the signal is transmitted, due to reflections and interference of the electromagnetic waves which are typical of this mode of transmission. On the other hand, when the transmitter operates in the second transmitting mode, for example, utilizing a single antenna or transmitting at relatively low power, the signal locator can more accurately determine the direction from which the signal is transmitted, since transmission in this mode substantially reduces reflections of the electromagnetic waves of the transmission. Thus, in the second transmitting mode, the signal locator can identify the direction of the location of the object on which the signaling device is mounted, although, typically the signal transmitted in the second mode is not strong enough to permit creation of a connection when the signal locator is relatively far from the signaling device. The selection and switching between the transmitting modes is carried out by a controller in the signaling device.

The transmitter may be coupled to an omnidirectional antenna, only. In this case, the signal is transmitted through the omnidirectional antenna at high power in the first transmitting mode, and is transmitted through the omnidirectional antenna at low power in the second transmitting mode. Alternatively, the transmitter may be coupled to an omnidirectional antenna and to at least one, and preferably a few unidirectional antennas. In this case, in the first transmitting mode, the signal is transmitted through the omnidirectional antenna and the unidirectional antennas. In the second transmitting mode, the signal is transmitted through one of the unidirectional antennas, only. When the signal is transmitted through the unidirectional antenna, the level of reflections and interference is relatively low, thus, permitting the signal locator to determine the direction from which the signal is transmitted. However, in this mode, if the unidirectional antenna is not directed towards the signal locator, the signal may not be detected.

Determination of the direction of the signal is preferably performed by a software application in the controller of the signal locator. As the user turns around, holding the signal locator against his or her body, the receiver receives signals at different energy levels. This data is stored and the controller can plot the amplitudes at which various signals are received, together with the direction the locator is pointing at the time.

The signal locator further includes at least one direction sensor, such as a compass or a 3 axis gyro sensor, utilized in iPhone devices, for detecting the direction towards which the signal locator is pointed at any given time. The direction sensor may be an optical gyroscope, which operates on the principle of the Sagnac effect, such as seen in a ring interferometry setup, where two beams traverse identical paths but opposite directions around a loop until reaching a detector. When the system is rotating, one of the beams travels a greater distance than the opposite traveling beam to reach the detector. This difference in path length (also known as a Doppler shift) is detected as a phase shift by interferometry. This phase shift is proportional to the angular velocity of the system. Often optical gyroscope units consist of 3 mutually orthogonal gyroscopes for rotation sensing about all three orthogonal rotation axes.

Alternatively, the direction sensors may be any other sensor for detecting the position and orientation of a device, such as a Vibrating Structure Gyroscope. The vibrating structure gyroscope is a Micro-machined Electro-Mechanical System (MEMS), which utilizes Coriolis force to calculate the change in orientation of an object. Coriolis force is proportional to the angular velocity of the rotating object and the velocity of the object moving towards or away from the axis of rotation.

When such direction sensors are incorporated in the signal locator, the controller in the signal locator can determine, from the signal amplitude data together with the directions indicated by the direction sensor, the direction from which the signal is transmitted, and provide an indication to the user of that direction. If the user then moves left or right to a new position relative to the signaling device, the direction sensors recalculate the direction of the signaling device, and the indication to the user changes accordingly. For example, if the signal locator detected that the signaling device is on the left of the user holding the signal locator, an indication, such as an arrow pointing to the left, is displayed on the screen of the signal locator. As the user turns toward the left, the direction sensor detects the user's movement and recalculates the position of the user. Thus, the arrow displayed on the screen may change to an arrow pointing ahead of the user.

It will be appreciated that indicating the new direction may be carried out by detecting again the amplitudes and directions from which the various signals are received. By using the software application to calculate the new position of the user and changing the indication accordingly, the change is carried out substantially simultaneously as the user moves. The signaling device may be mounted on objects that users frequently misplace or lose. Thus, the locating system according to the present invention can be used to assist the user to locate a signaling device mounted on the misplaced object by providing the user with a visual indication pointing in its direction.

Preferably, the signal locator is incorporated in a cellular phone having a low power transceiver, such as a Bluetooth or Wi-Fi transceiver, or other low energy transceiver. The transceiver may be utilized to transmit a prompting signal for actuating the signaling device into a transmitting mode, and to receive an identification signal, transmitted by the prompted signaling device in response to the prompting signal. Accordingly, the direction from which the signal is transmitted can be identified by the signal locator and indicated by displaying an arrow, for example, on the screen of the cellular phone pointing in the direction of the object.

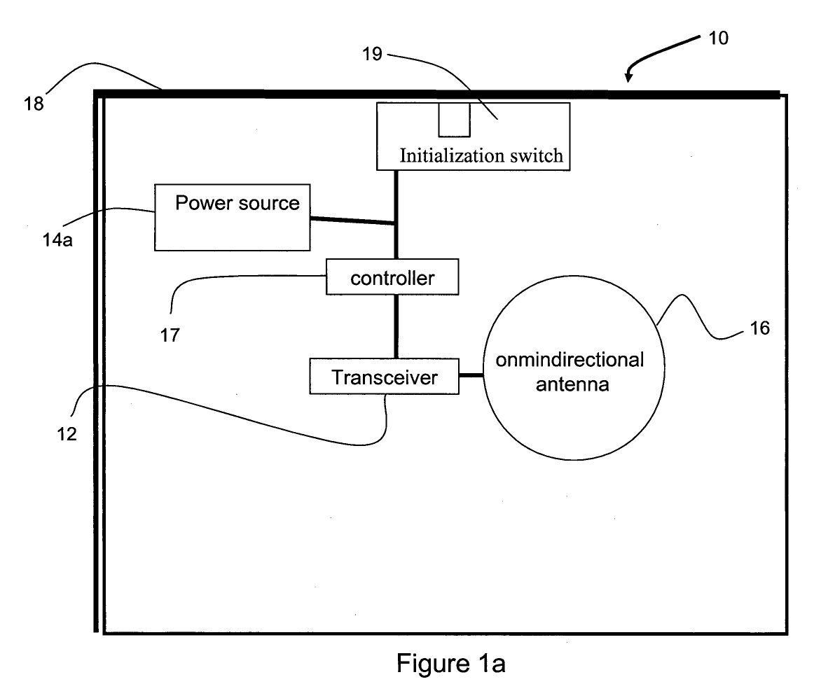

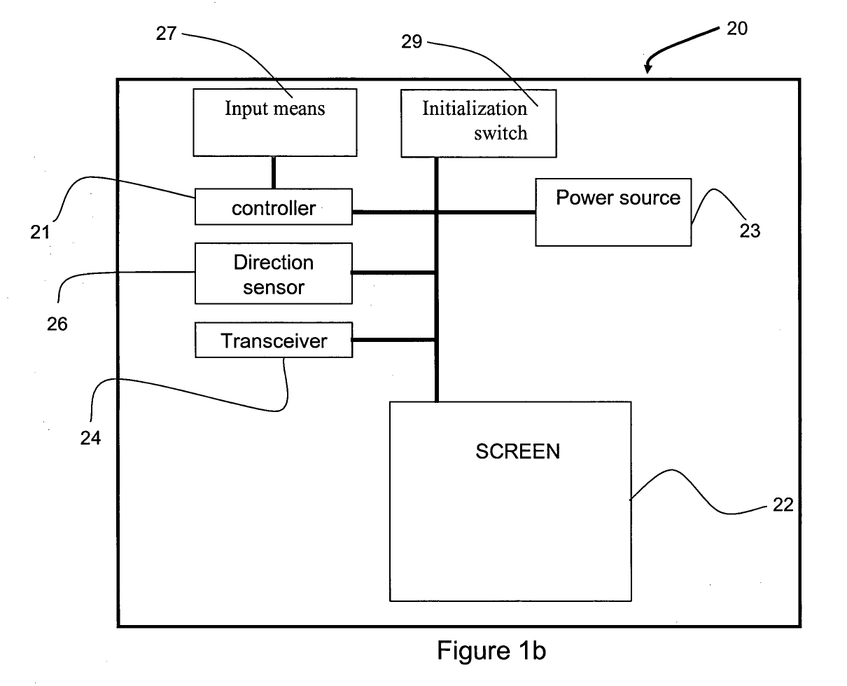

FIG. 1a is a schematic block diagram illustrating a signaling device 10, constructed and operative in accordance with one embodiment of the present invention. Signaling device 10 includes a signaling transceiver 12 for transmitting an identification signal. Transceiver 12 is coupled to at least one antenna 16, which is preferably an omnidirectional antenna transmitting a signal in all directions, thus, increasing the chances that the signal will be detected by a signal locator.

Signaling device 10 further includes a controller 17, coupled to transceiver 12 and antenna 16, for controlling the operation of transceiver 12. For example, controller 17 may control the activation of transceiver 12, the duration of the signals transmitted by transceiver 12, and preferably, the transmission power. Controller 17 holds identification data, particularly a unique identification code carried by the transmitted signal, as well as information relating to the object on which the signaling device is being mounted, which is pre-defined by the user via any conventional user interface.

In addition, signaling device 10 includes a mounting element 18, here illustrated as an adhesive layer, for coupling to an object. Mounting element 18 can be utilized for coupling signaling device 10 to an object, such as a briefcase, passport, keychain, spectacles, etc. It will be appreciated that mounting element 18 can vary depending on the object on which signaling device 10 is to be mounted.

Preferably, signaling device 10 further includes an initialization switch 19 coupled to controller 17, for initializing the signaling device 10. Upon activation, switch 19 actuates controller 17 which, in turn, creates an electronic association with a signal locator, as explained hereafter.

FIG. 1b is a schematic block diagram illustrating a signal locator 20, constructed and operative in accordance with one embodiment of the present invention. Signal locator 20 includes a locator transceiver 24 for transmitting and receiving signals to and from the signaling device. The locator transceiver can identify the signaling device whose transmission is received with the lowest or highest energy level, as preferred. According to one embodiment, signal locator 20 includes means for displaying the energy level of the received signal. The energy level may indicate when signal locator 20 is in close proximity to signaling device 10, thereby assisting the user holding the signal locator while searching for the object on which signaling device 10 is mounted.

Preferably, signal locator 20 further includes a direction sensor 26, which outputs coordinates or another data indicating the direction towards which the signal locator is pointing.

Locator transceiver 24 and direction sensor 26 are coupled to a power source 23, such as a rechargeable battery, and to a locator controller 21, for controlling and monitoring the communication with the signaling device, and for controlling the operation of transceiver 24. Controller 21 preferably stores the software application which takes the signal strength data with the direction sensor data, determines the direction from which the identification signal is received, and outputs an indication to the user of the direction towards the signaling device. The application may run on controller 21 or on the CPU of the signal locator device, if it has one, such as a cellular phone.

Preferably, signal locator 20 further includes a screen 22 for displaying a visual indication, for example, an arrow pointing to the direction in which the signaling device has been determined to be located, and/or for displaying the energy level of the received signal. Alternatively, signal locator 20 may be provided with an audible indicator for indicating the detected direction and/or the energy level of the received signal. For example, signal locator 20 may include a set of LEDs, each of which indicates a specific direction, such as right, left, forwards or backwards. The visual indication is generated in accordance with the direction determined by the signal locator.

Signal locator 20 is configured to operate in electronic association with one or more signaling devices. Electronic association is known in the art and is implemented, for example, when coupling a cellular phone having Bluetooth capabilities with a Bluetooth device, such as a Bluetooth headphone. According to this association, both the cellular phone and the headphone are configured to operate in a search mode, in which the cellular phone sends a Bluetooth transmission for detecting Bluetooth devices in its vicinity. Upon detection of the headphone, the cellular phone sends a preset code which is inserted into the headphone, which, in turn, is registered as a Bluetooth device associated with the cellular phone. After establishing the association between the two devices, the headphone can be automatically electronically coupled with the cellular phone upon activation of the headphone.

Similarly, in the present invention, a signaling device is electronically associated with signal locator 20, allowing signal locator 20 to activate a desired signaling device by a prompting signal. Such electronic association between the signal locator and the signaling device permits a signaling device to be activated only by a prompting signal which is sent by an electronically associated signal locator, so as to avoid undesired activation of other signaling devices in proximity to the signal locator. Furthermore, the electronic association between a signal locator and a signaling device allows signal locator 20 to identify the signaling device based on the predefined identification code. Accordingly, signal locator 20 may be utilized to locate more than one signaling device, each transmitting a different identification signal. It will be appreciated that in such a case, the indication of the direction provided for the user includes an indication regarding which signaling device has been detected. Preferably, forming the electronic association in carried out by activating the initialization switch 29 provided on signal locator 20. The electronic association is performed, at the time the signaling device is being mounted on an object, by activating initialization switch 19 on the signaling device. This prompts the transmitter of the signaling device to transmit a pairing signal. The pairing signal is received by the signal locator, which registers the signaling device. It will be appreciated that once the signaling device is associated with the signal locator, the signal locator can identify the signals transmitted by the signaling device. Once this initialization has been performed, electronic coupling can be accomplished automatically whenever the signaling device is activated in proximity to the signal locator.

Signal locator 20 may further include a user interface or other input means 27 for inputting information regarding the signaling device. This is particularly important when the signal locator is electronically associated with more than one signaling device. This way, when the user wishes to locate an object on which a first signaling device is mounted, he or she can input predefined identification data related to the first signaling device, so that signal locator 20 will locate the first signaling device. Similarly, if the user wishes to locate a different object on which a second signaling device is mounted, he or she can input predefined identification data related to the second signaling device, so that signal locator 20 will locate the second signaling device, instead.

Signaling device 10 and signal locator 20 utilize a transmission protocol, which governs the format and manner in which the communication between the signaling device and the signal locator takes place. Preferably, the transmission protocol is configured for low power transmission, which is effective over a short range and does not require high energy.

According to one embodiment, the transmission protocol may be a dedicated protocol, which preferably includes short pattern, i.e., each session is a specific session which requires few instances, so as to save energy. For example, when signaling device 10 is periodically actuated in order to check for prompting signals from signal locator 20, the protocol may include commands which are directed to searching for a prompting signal from a specific, pre-associated signal locator, and not from any other device. In this way, the instance of checking for prompting signals can be very short and does not require much energy. Similarly, if signal locator 20 is electronically associated with more than one signaling device 10, signaling device 10 does not check, in every session, if signal locator 20 is transmitting a prompting signal, and if the prompting signal is directed to this signaling device. Rather, during the periodic session, signaling device 10 only checks whether signal locator 20 is transmitting a prompting signal. Only when a prompting signal from signal locator 20 is detected, a separate session in signaling device 10 is actuated, verifying that the prompting signal is directed to this signaling device. This way, each session can be very short, and thus consumes relatively little energy. It will be appreciated that when a dedicated transmission protocol is provided, a compatible transmitter, configured to transmit in accordance with the transmission protocol, may be provided, as well. Alternatively, the protocol may be part or all of a conventional short range protocol, such as Bluetooth®, Wi-Fi®, or Radio Frequency Identification (RFID).

According to one embodiment, the signal locator is a standalone device. However, alternatively, the signal locator may be incorporated in another device, for example, a cellular phone, a handheld computing device, such as a Personal Digital Assistant, etc.

In the latter case, the direction sensor can be the direction sensors which are available in certain cellular phones. The screen of the cellular phone can be used for displaying the direction indication. In addition, communication with the signaling device may be carried out using the short range transmission protocol available in cellular phones and handheld devices, such as Bluetooth®, Wi-Fi®, etc., and the application for determining the signal direction may run on the CPU of the cellular phone or handheld device. However, in addition or alternatively, the cellular phone may be provided with a dedicated transceiver and transmission protocol, such as explained herein above, for communication with the signaling device. In that case, the transmission protocol and the transceiver may be incorporated in an add-on device, e.g., mounted on an electronic card configured to be plugged into a memory slot in a conventional hand held computing device or cellular phone, etc.

In this way, a user who wishes to utilize a standard cellular phone as a signal locator may couple to an existing port in the phone a memory card which holds a transceiver, which is configured to communicate with the signaling device, and the appropriate software application.

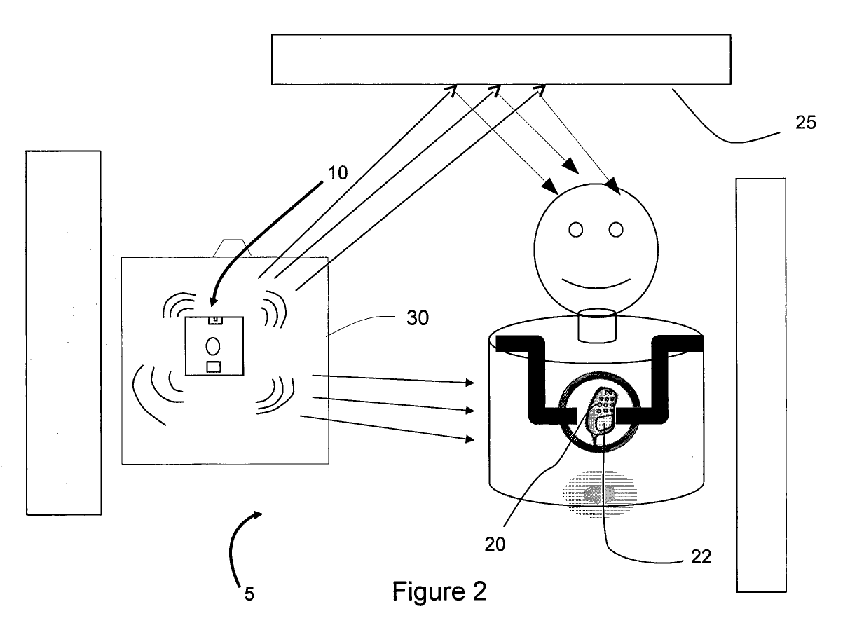

FIG. 2 is a schematic illustration of a system 5 for locating objects, constructed and operative according to the present invention. System 5 includes a signaling device 10 of FIG. 1a mounted on an object, here illustrated as a briefcase 30, and a signal locator 20 of FIG. 1b. When a user wishes to locate briefcase 30, he or she activates signal locator 20, which has been electronically associated with signaling device 10. Signal locator 20 transmits a prompting signal which is received by signaling device 10. It will be appreciated that, if more than one signaling device is associated with signal locator 20, the user may input, via the input means, pre-stored identification data related to the signaling device he or she is trying to locate, for example, the name of the object on which the signaling device is mounted. In accordance with the user's input, the prompting signal may include an identification code, so as to activate only the desired signaling device.

In response to the prompting signal, the controller on signaling device 10 activates its transceiver to transmit an identification signal. The identification signal is received by signal locator 20. The direction sensor in signal locator 20 determines in which direction the signal locator was pointing when the signals at various energy levels were received. The controller in the signal locator plots the data of the energy levels (amplitude) of received signals and the direction from which they were received. The controller now determines which is the lowest or highest energy signal that was received, and the direction it came from.

It will be appreciated that either the signal with the lowest amplitude or the signal with the highest amplitude can be chosen to orient the signal locator. Selecting the signal with the lowest amplitude is believed to give the most accurate signal, as the user's body absorbs much of the signal and there are few reflections which are received by the signal locator. Thus, when the direction of the lowest amplitude signal is determined, the controller will calculate that the signaling device is directly behind (180°) the user.

The controller preferably generates an indication, on the screen 22 or other indicating means, the direction to the signaling device. As the user holding signal locator 20 moves closer to the area where signaling device 10 is located, the direction-indication may change in accordance with the position of signal locator 20 relative to signaling device 10, thus guiding the user to the object on which signaling device 10 is mounted. For example, if the controller detects that the desired signal is received from the left side, the visual indication, such as an arrow, will point to the left side.

Alternatively, only the energy level of the received signal may be displayed on screen 22 or indicated in another fashion. As the user holding signal locator 20 turns his or her body left or right, the energy level displayed by the signal locator changes, thus indicating to the user from which direction the signal is received. As the user holding signal locator 20 gets closer to the area where signaling device 10 is located, he may turn again left or right, until signal locator 20 detects the direction from which the signaling device is transmitting.

In some cases, due to reflections and interferences of the electromagnetic waves, the identification signal may be received from more than one direction. For example, if the electromagnetic wave carrying the identification signal encounters an obstacle, here illustrated as wall 25, a portion of the wave is reflected and signal locator 20 receives the identification signal from the direction of wall 25, in addition to receiving the signal directly from signaling device 10. In this case, signal locator 20 may not be able to accurately detect the direction from which the signal is transmitted.

However, if the user holds signal locator 20 in close proximity to his or her body, for example adjacent his or her chest, his body mass serves as electromagnetic screening between signaling device 10 and signal locator 20. It will be appreciated that in order to reduce transfer of the electromagnetic waves through the user's body, transceiver 12 in signaling device 10 is configured to transmit relatively low power waves.

According to some embodiments of the invention, transceiver 12 in signaling device 10 is configured to transmit in a first transmitting mode, or contact mode, utilizing the full power of the transceiver, and in a second transmitting mode, or operational mode, utilizing low power of the transceiver. In the second transmitting mode, the degree of reflection and interference is low. In addition, in the second transmitting mode, controller 17 may cause the transmitter to transmit more frequently, so as to allow signal locator 20 to more rapidly and accurately detect the direction. Furthermore, since the user carrying signal locator 20 is constantly moving while searching for the lost object, the direction from which the signal is received, relative to the position of signal locator 20, dynamically changes. Thus, when the signal is received more frequently, signal locator 20 can dynamically change the direction indication, and guide the user more quickly to the object to be located.

When a prompting signal is received by signaling device 10, signaling transceiver 12 transmits an identification signal in the full power mode. When the identification signal is received and identified by signal locator 20, signal locator 20 sends signaling device 10 a verification signal. When the verification signal is received by signaling device 10, controller 17 inside signaling device 10 shifts transceiver 12 to the low power mode. Alternatively, controller 17 may shift to the low power mode after a preset period of time, regardless of receipt of a verification signal. The level of power in the low power mode is the minimal power at which the signal can be received by the signal locator. It will be appreciated that, in order to allow controller 17 to gradually reduce the power, feedback signals can be sent back and forth between signal locator 20 and signaling device 10. Preferably, the reduction of the transmission power is carried out gradually, so as to avoid a situation in which the power is too low to be detected by signal locator 20.

In order to assure that signal locator 20 receives the signal from the signaling device while controller 17 is lowering the transmitting power, a verification signal may be transmitted by signal locator 20 every predetermined period of time. Alternatively, in case the transmitting power is too low, and the identification signal is not received by signal locator 20 for a pre-set period of time, for example, 2 seconds, signal locator 20 may be configured to send another prompting signal. In response to the prompting signal, the signaling device increases the transmission power. It will be appreciated that lowering and/or increasing the transmission power may be carried out more than once. In fact, it may be carried out until the object, on which the signaling device is mounted, is found, and the signaling device is deactivated.

Once the object, on which the signaling device is mounted, has been located, the signaling device is preferably deactivated, i.e., the signaling device stops transmitting signals and only periodically checks for prompting signals. Deactivation of signaling device 10 may be carried out by pressing a deactivation switch (not shown) provided on signaling device 10. Alternatively, deactivation may be carried out by pressing a deactivation switch on signal locator 20 which, in response, sends a deactivation signal to the signaling device.

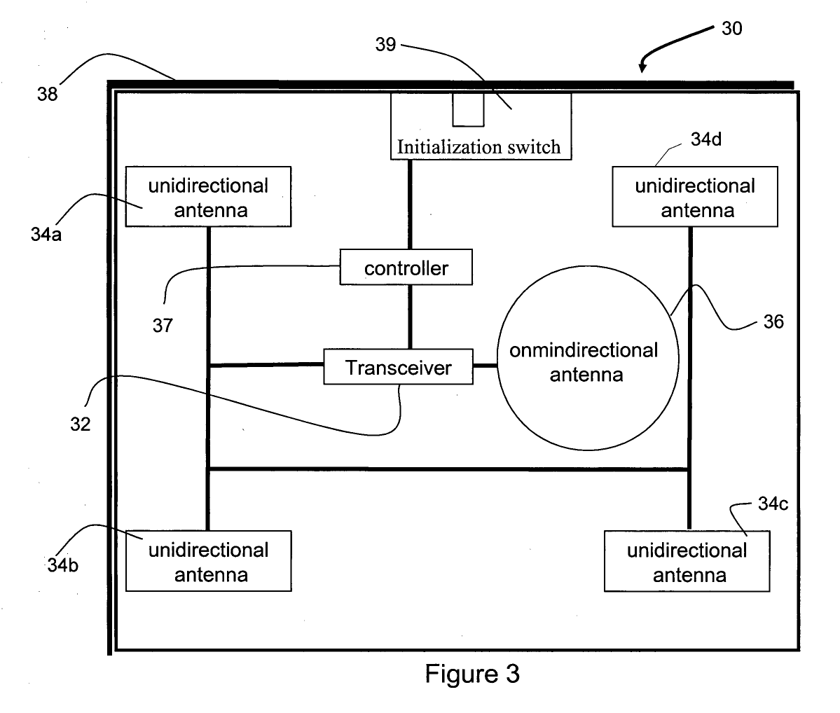

FIG. 3 is a block diagram illustrating a signaling device 30 constructed and operative in accordance with another embodiment of the present invention. Signaling device 30 includes a signaling transceiver 32 for transmitting an identification signal. Transceiver 32 is coupled to at least two, and preferably, a plurality of unidirectional antennas 34. Each unidirectional antenna 34 can receive and transmit a signal substantially in one direction. In the illustrated embodiment, signaling transceiver 32 is coupled to four unidirectional antennas 34a-34d. On the one hand, transmitting through one of unidirectional antennas 34a-34d minimizes interference caused by reflections of the signal's wave, but on the other hand, in the event that the transmitted beam is not pointing in the direction of the signal locator, the signal locator may not detect this transmission. Preferably, transceiver 32 is further coupled to at least one omnidirectional antenna 36, which transmits a signal in all directions. Though transmitting through omnidirectional antenna 36 increases the chances of detecting the signal by a signal locator, it also increases reflections and interference of the signal's wave, which reduces the chances of the signal locator identifying the direction of the transmitted signal.

Signaling device 30 further includes a signaling controller 37 coupled to transceiver 32 and antennas 34a-34b and 36, for controlling the operation of transceiver 32 and the antennas. Controller 37 determines the power of the prompting signal received in each of unidirectional antennas 34a-34d from the signal locator. Accordingly, the unidirectional antenna 34a, 34b, 34c, or 34d which received the strongest signal is selected by the controller as the antenna best positioned to communicate most efficiently with the signal locator. Then, controller 37 selects only this antenna to transmit the locating signal, since its transmission beam is most likely to be received by the signal locator.

In addition, signaling device 30 includes a mounting element 38, which can be any conventional means for securing the signaling device to an object.

Preferably, signaling device 30 further includes an initialization switch 39 coupled to controller 37, for initializing signaling device 30, as explained above with regard to FIG. 1.

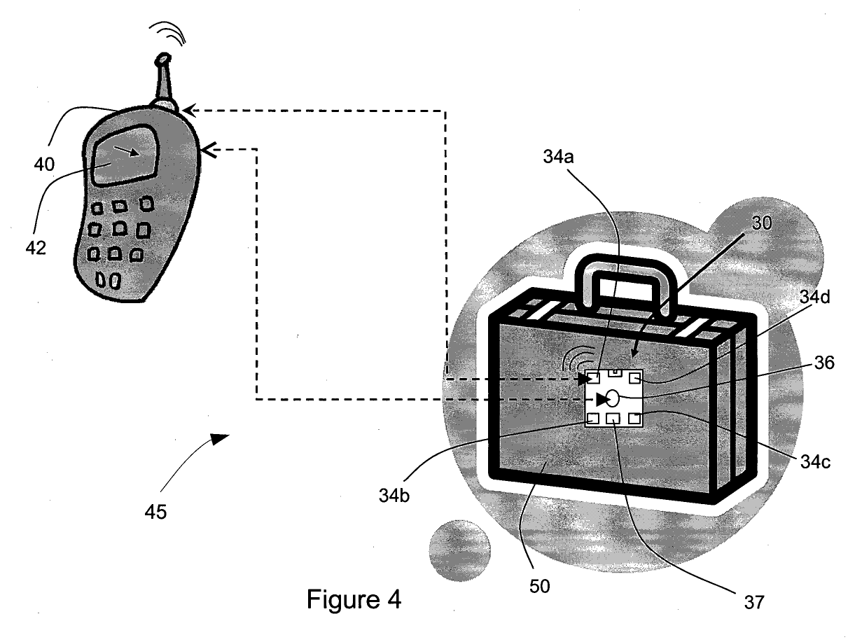

FIG. 4 is a schematic block diagram illustrating a system 45 for locating objects, constructed and operative according to the present invention. System 45 includes a signaling device 30 of FIG. 3 mounted on an object, here a briefcase 50, and a signal locator 40. When a user wishes to locate briefcase 50, he activates signal locator 40, here illustrated as a cellular phone having a screen 42, which has been electronically associated with signaling device 30. Signal locator 40 transmits a prompting signal which is received by antennas 34a-34d and 36 in signaling device 30. It will be appreciated that, if more than one signaling device is associated with signal locator 40, the prompting signal will be encoded, so as to activate only the desired signaling device 30.

In response to the prompting signal, controller 37 activates transceiver 32 (shown in FIG. 3) to transmit an identification signal through antennas 34a-34d and 36. Once a connection has been established between the signaling device and the signal locator, the controller determines which of the unidirectional antennas 34a-34d is oriented to the highest degree towards the source of the prompting signal, i.e. signal locator 40. This is carried out by determining the reception level of the signal in each unidirectional antenna 34a-34d. The antenna with the highest reception level, here illustrated as 34a, is selected to transmit the locating signal, so that the signaling device is transmitting in a low power or partial mode.

According to one embodiment, once the transmitted identification signal is received by signal locator 40, a verification signal is sent to signaling device 30. In response, signaling controller 37 switches the transmitting mode of the transceiver. In this embodiment, switching from the first transmitting mode to the second transmitting mode is implemented automatically by the controller 37 deactivating omnidirectional antenna 36 and the unidirectional antennas 34b-34d which were not selected to transmit. In this way, the identification signal is transmitted only via one unidirectional antenna, which is found to be oriented towards signal locator 40.

According to an alternative embodiment, the deactivation of the omnidirectional and unidirectional antennas (i.e., switching to the second transmitting mode) is carried out automatically at the expiration of a predefined time period from receipt of the verification signal.

When signal locator 40 receives the identification signal, transmitted only by one unidirectional antenna, for example, unidirectional antenna 34a, the direction from which the identification signal is received can be determined. This is due to the fact that transmitting through a unidirectional antenna substantially reduces interference caused by reflections. It will be appreciated that detecting the direction from which the identification signal is received may be carried out in any manner in signal locator 40, for example as explained above. A software module, receiving input from the direction sensor in signal locator 40 and from the transceiver, generates a visible illustration indicating the direction from which the signaling device is transmitting, which points to the object on which signaling device 30 is mounted. This visual indication can be, for example, an arrow displayed on screen 42. Alternatively, signal locator 40 may be provided with a set of LEDs, each of which indicates a specific direction. The LED or LEDs pointing in the determined direction can be illuminated by a signal from the controller.

The signaling device can be configured to transmit an identification signal every preset period of time, for example, every 5 minutes. The signal is received by the signal locator, which also records the reception time of the signal on its internal memory. When desired, the user can view the time of reception of the signal. If the user recollects his location at that time, he may deduce the location of the lost object which was within the reception radius of the signal locator at that time.

According to one embodiment, the signaling device and the signal locator may be utilized for providing an alert when the user's pocket has been picked. This is carried out by activating the signaling device to constantly transmit signals, and by activating the signal locator to search for the signal from the signaling device. The signal locator may be configured to alert the user in case a signal is not received after a predefined period of time. When a signal is not received, the user may suspect the object on which the signaling device is mounted is not in close proximity, i.e., the object might have been stolen or left behind.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system for locating an object, the system comprising:
a signaling device for mounting on an object, said signaling device including a signaling transceiver transmitting an identification signal; and
a signal locator including:
a locator transceiver for receiving a signal directly from said signaling device;
a direction sensor for sensing a direction towards which said signal locator is pointing;
a locator controller determining, from said received signal and from said sensed direction, a direction from which said identification signal is received by said signal locator; and
an indicator indicating said direction.

2. The system according to claim 1, wherein
said signaling transceiver is a variable transmit power transceiver; and
said signaling device further includes a signaling controller coupled to said signaling transceiver;
wherein said signaling controller automatically switches said transmitter between a contact mode, to establish contact with the signal locator, and an operational mode, to permit determination by the signal locator of said direction, after said contact has been established.

3. The system according to claim 1, wherein said indicator includes a display for providing a visible indication of said direction.

4. A signaling device for sending signals to a signal locator, the device comprising:
a transceiver configured for selectively transmitting a signal in a first transmitting mode, to establish contact with the signal locator, and for transmitting said signal in a second transmitting mode after said contact has been established, to permit determination by the signal locator of a direction from which said signal was received; and
a controller for automatically switching between said first and second transmitting modes.

5. The device of claim 4, further comprising:
an omnidirectional antenna coupled to said transceiver;
wherein said first transmitting mode includes transmitting through said omnidirectional antenna at high power, and said second transmitting mode includes transmitting through said omnidirectional antenna at low power.

6. The device of claim 4, further comprising:
an omnidirectional antenna coupled to said transceiver; and
at least two unidirectional antennas coupled to said transceiver;
wherein said first transmitting mode includes transmitting through said omnidirectional antenna and said at least two unidirectional antennas, and said second transmitting mode includes transmitting through at least one of said at least two unidirectional antennas.

7. The device according to claim 4, wherein said signaling device includes a signaling activation switch to activate the signaling controller and said signal locator includes a locator activation switch for activating said locator controller to create an electronic association between said signaling device and said signal locator.

8. The device according to claim 4, wherein
said signaling controller stores a predefined identification code; and
said signal locator further includes a user interface for inputting identification data related to an object on which said signaling device is mounted.

9. The device according to claim 4, wherein said device is a device selected from the group including a cellular phone and a hand held computing device or PDA.

10. The device according to claim 1, wherein said signal locator is mounted on an electronic card configured to be plugged into a memory slot in a conventional hand held computing device or cellular phone.

11. A method for locating an object having a signaling device, the method comprising:
receiving, in a signal locator, an identification signal directly from a signaling device;
sensing, in said signal locator, a direction towards which said signal locator is pointing;
determining, from said identification signal and said sensed direction, a direction from which said identification signal is received by said signal locator;
and providing an indication of said direction.

12. A method for locating an object having a signaling device, the method comprising:
receiving a prompt signal from a signal locator in said signaling device;
transmitting an identification signal in a contact mode by said signaling device in response to said prompting signal;
automatically switching to an operation mode in said signaling device; and
transmitting said identification signal in said operation mode.

13. The method according to claim 12, further comprising receiving a verification signal from said signal locator, before said step of automatically switching.

14. The method according to claim 11, further comprising:
receiving, in said signal locator, an identification signal transmitted by said signaling device in a first transmitting mode;
identifying and verifying said identification signal;
receiving, in said signal locator, said identification signal transmitted by said signaling device in a second transmitting mode; and
determining from said transmitted signals, in said signal locator, a direction from which said signaling device transmitted.

15. The method according to claim 12, wherein:
said step of transmitting in a contact mode includes transmitting an identification signal at full power for making contact;
said step of transmitting in said operation mode includes transmitting said identification signal at low power for determining said direction; and
said step of switching includes reducing transmit power.

16. The method according to claim 12, wherein:
said step of transmitting in a contact mode includes transmitting an identification signal through multiple antennas for making contact;
said step of transmitting in said operation mode includes transmitting said identification signal through a single antenna for determining said direction; and
said step of switching includes turning off all except one of said antennas.

17. The method according to claim 11, further comprising providing a visible indication of said determined direction.

18. The method according to claim 11, further comprising creating an electronic association between said signaling device and said signal indicator before said first step of receiving.

19. The system according to claim 2, wherein said indicator includes a display for providing a visible indication of said direction.

20. The device of claim 4, wherein:
said first transmitting mode includes transmitting at a first rate of transmission, and
said second transmitting mode includes transmitting at a second rate of transmission, faster than said first rate of transmission.
